(19) United States
(12) Patent Application Publication
(10) Pub. No.: US 2004/0208441 A1
(43) Pub. Date: Oct. 21, 2004

(54) Method for fabricating a fiber lens

(75) Inventors: Wood-Hi Cheng, Kaohsiung (TW); Huei-Min Yang, Kaohsiung (TW); Shih-En Chang, Kaohsiung (TW); Chao-Wei Lee, Taipei (TW); Shih-Hung Wang, Kaohsiung (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: National Sun Yat-Sen University

(21) Appl. No.: 10/827,084

(22) Filed: Apr. 19, 2004

(30) Foreign Application Priority Data
Apr. 21, 2003 (TW) 092109218

(51) Int. Cl. G02B 6/32

(52) U.S. Cl. 385/33

(57) ABSTRACT

The invention is directed to a method for fabricating a fiber lens, comprising: (a)stripping proper length of the coating layer of a fiber to form a bare fiber portion; (b)cleaning the bare fiber portion; (c)fixing the fiber into a ferrule included in a holder; (d)providing a container filled with a layer of hydrofloride, a layer of oil and a middle mixed layer; (e)immersing the bare fiber portion in the container, wherein the bare fiber portion is etched by the layer of hydrofloride and the fiber is perpendicular to the surface of the layer of oil to form a cone; (f)melting the cone by a plurality of electric arcs to form a fiber lens; and (g)adjusting the relative position between the electric arcs and the cone to form the desired curvature and shape of the fiber lens.

### FIELD OF THE INVENTION

The present invention relates to a method for fabricating a fiber lens, particularly to a method for adjusting the relative position between the arc and the etched cone to form the desired curvature and shape of the fiber lens.

### DESCRIPTION OF THE RELATED ART

Coupling efficiency is one of the most important characteristics of an optical fiber. In order to enhance the coupling efficiency between diode laser and fiber, a lensed optical fiber has been used, in which a tapered lens is formed on the end face of the optical fiber to match the waveform of the laser beam and that of the fiber. The conventional types of the lensed fiber are hemispherical-end fiber and hyperbolic-end fiber.

There are two typical methods for fabricating the hemispherical-end fiber. One is to stretch and then cut the fiber to have a tapered appearance by utilizing a circle-cutting apparatus. Such a fiber lens has high coupling efficiency, but the disadvantage of the method is that only one fiber is fabricated at one time, and therefore, it is not economical in commercial use. The other typical method is to polish the fiber to form the tapered end by utilizing a polishing machine. Such a fiber lens also has high coupling efficiency, but the fabrication takes much time, and the yield is limited. In addition, the above two methods can form the curvature that we need, but the final profile of the fiber lens is not perfect, which causes low coupling efficiency. As shown in studies, these hemispherical microlenses with taper asymmetry have demonstrated imperfect coupling with a typical coupling efficiency of 50%.

Recently, hyperbolic-shaped microlenses fabricated directly on the end of the fiber by CO₂ laser micromachining have demonstrated up to 90% coupling efficiency. The high-coupling performance of hyperbolic microlenses represents a major advance in microlens technology compared to currently available hemispherical microlenses, which show the best coupling efficiency of 65%. The hyperbolic microlens almost exactly transforms the incident spherical wave into a plane wave according to geometric optics. However, the present hyperbolic-shaped microlenses only can be fabricated by mechanicl machining, which takes much time and only one fiber is fabricated at one time.

Consequently, there is a need for providing a method for fabricating a fiber lens to solve the above-mentioned problem.

### SUMMARY OF THE INVENTION

The primary objective of the present invention is to raise the coupling efficiency by utilizing a ferrule to clamping the fiber so that the fiber can remain perpendicular to the surface of the etching solution and reduce the offset between the axis of the fiber lens and the axis of the fiber.

Another objective of the present invention is to raise the coupling efficiency by adjusting the relative position between the electric arcs and the etched cone to form the desired curvature and shape of the fiber lens, such as hyperbolic or hemispherical.

Another objective of the present invention is that, in comparison with other typical methods, the fabrication process according to the present invention is reproducible and suitable for high volume production because more than 200 fibers could be tapered together at any one time.

To achieve the above objectives, the present invention provides method for fabricating a fiber lens, comprising:

(a) stripping proper length of the coating layer of a fiber to form a bare fiber portion;

(b) cleaning the bare fiber portion;

(c) fixing the fiber into a ferrule included in a holder;

(d) providing a container filled with a layer of hydrofloride, a layer of oil and a middle mixed layer;

(e) immersing the bare fiber portion in the container, wherein the bare fiber portion is etched by the layer of hydrofloride and the fiber is perpendicular to the surface of the layer of oil to form a cone;

(f) melting the cone by a plurality of electric arcs to form a fiber lens; and

(g) adjusting the relative position between the electric arcs and the cone to form the desired curvature and shape of the fiber lens.

The method and characteristics of this invention can be realized by referring to the appended drawings and explanations of the preferred embodiments.

### BRIEF DESCRIPTION OF THE DRAWINGS

FIG. 1 is a flow chart illustrating a method for fabricating a fiber lens according to the present invention;

FIG. 2 is a schematic perspective view of a etching apparatus according to the present invention;

FIG. 3 is a partial enlarged view of FIG. 2, which shows the etching principle according to the present invention;

FIG. 4 is a schematic perspective view of a fusion apparatus according to the present invention;

FIG. 5 shows the relationship between the coupling efficiency and the radius of curvature of the fiber lens, wherein the fiber lens is hemispherical;

FIG. 6 shows the relationship between the coupling efficiency and the radius of curvature of the fiber lens, wherein the fiber lens is hyperbolic;

FIG. 7 shows the photo paragraph of hemispherical fiber lens according to the present invention;

FIG. 8 shows the photo paragraph of hyperbolic fiber lens according to the present invention; and

FIG. 9 shows the relationship between the coupling efficiency and the offset, wherein the fiber lens is hemispherical.

### DETAILED DESCRIPTION OF THE INVENTION

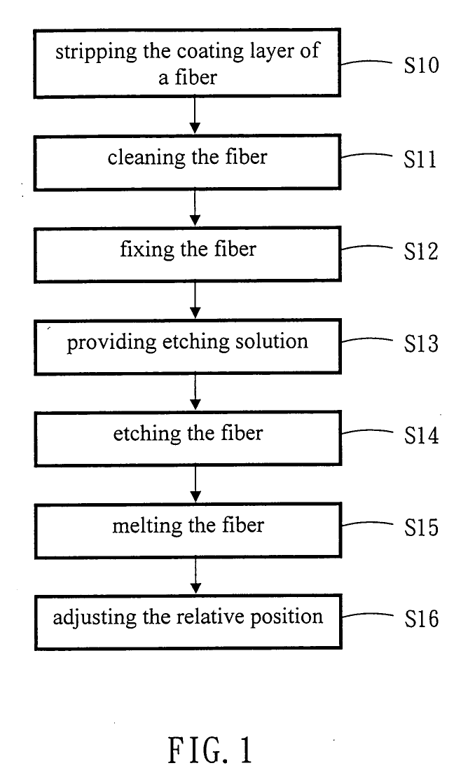

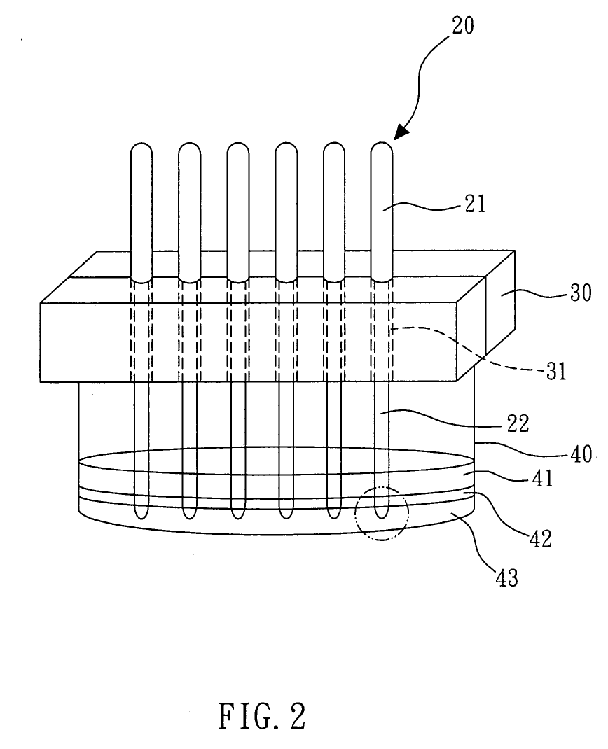

FIGS. 1 and 2 respectively show a flow chart and an etching apparatus according to the present invention. In step S10, a proper length of the coating layer of the fiber 20 to be fabricated is stripped so as to form a bare fiber portion 22. Therefore, the fiber 20 is divided into two parts, one of which being the coated portion 21, and the other one being the bare fiber portion 22.

In step S11, the bare fiber portion 22 of the fiber 20 is cleaned. In the preferred embodiment, the bare fiber portion 22 is cleaned by acetone, alcohol and deionized water.

In step S12, the fiber 20 to be fabricated is fixed in a ceramic ferrule 31 of a holder 30, as shown in FIG. 2. The holder 30 has a plurality of through holes, each of which has a ceramic ferrule 31 to fasten the fiber 20 to be fabricated; wherein the inner radius of the ceramic ferrule 31 is equal to that of the fiber 20.

In step S13, a container 40 filled with etching solution is provided. In the preferred embodiment, the etching solution consists of hydrofloride (HF) and oil, and the container 40 is an acid resisting Teflon beaker in which the hydrofloride and oil are added in sequence to form a layer of hydrofloride 43, a middle mixed layer 42 and a layer of motor oil 41.

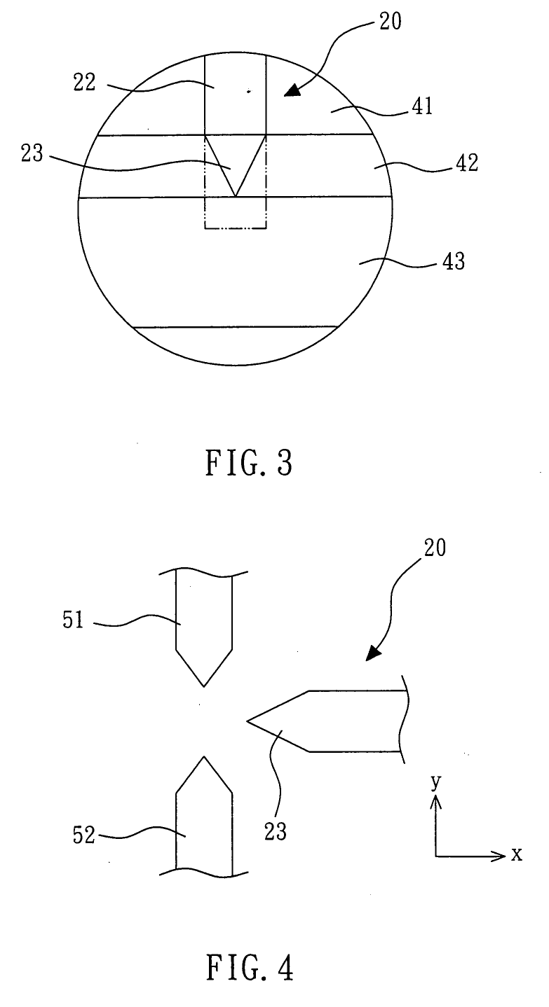

In step S14, the holder 30 is disposed above the container 40 so that the bare fiber portion 22 is immersed in the layer of hydrofloride 43 to proceed with etching and form a cone on the end of the bare fiber portion 22. As shown in FIG. 3, the etching principle is due to the middle mixed layer 42 that is between the layer of hydrofloride 43 and the layer of motor oil 41. The concentration of hydrofloride in the middle mixed layer 42 exhibits a gradient variation, that is, the concentration decreases as the elevation rises. Therefore, the bare fiber portion 22 that immersed in the layer of hydrofloride 43 can be dissolved completely, and the bare fiber portion 22 that is in the middle mixed layer 42 will be etched to form a cone 23 due to the gradient concentration of hydrofloride.

The thickness of the layer of hydrofloride 43 has no influence on the cone 23, but the higher concentration of the hydrofloride will cause shorter etching time and will affect the thickness of the middle mixed layer 42. The concentration of the hydrofloride is about 40% to 60%. In the preferred embodiment, the concentration of the hydrofloride is 55%.

The concentration and thickness of the layer of oil 41 will influence the thickness of the middle mixed layer 42. If the concentration or thickness of the layer of oil 41 is too high, the thickness of the middle mixed layer 42 will be too thin, and therefore, the cone 23 will be too large and the length of the cone 23 will be too short. If the concentration or thickness of the layer of oil 41 is too low, the thickness of the middle mixed layer 42 will be too thick; therefore, the cone 23 will be too long. In the preferred embodiment, the thickness of the layer of oil 41 is 2 mm.

Because the ceramic ferrule 31 has high precision, the inner radius thereof is fabricated to be equal to the outer radius of the fiber 20 so that the fiber 20 can be inserted tightly into the ceramic ferrule 31 that is then clamped in the holder 30. After the edge of the opening of the container 40 is is ground to be flat and the holder 30 is disposed on the opening of the container 40, the fiber 20 is perpendicular to the surface of the layer of oil 41.

After a proper etching time, for example, 30 to 45 minutes in the embodiment, the fiber 20 is taken out and then cleaned again by acetone, alcohol and deionized water, as step S11.

Step S15 is a fusion process, as shown in FIG. 4, and the cone 23 is molten by two electric arcs 51,52 to form a fiber lens.

Finally, in step S16, the relative position between the two electric arcs 51,52 and the cone 23 is adjusted to form the desired curvature and shape of the fiber lens. This is because the radius of the curvature of the fiber lens has critical influence on coupling efficiency. Large radius of the curvature of the fiber lens will cause relative high Snell's reflection and lower the coupling efficiency, whereas small radius of the curvature of the fiber lens will cause relative low Snell's reflection but cannot provide a suitable path to couple the laser beam into the fiber 20, and the coupling efficiency is also lowered. Therefore, a proper radius of the curvature of the fiber lens is an important factor.

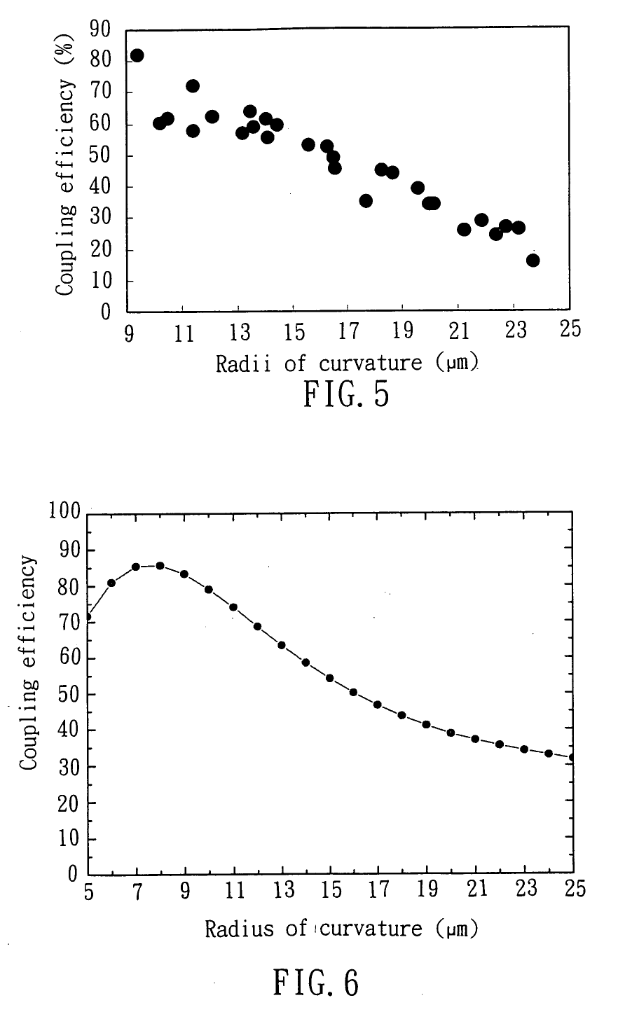

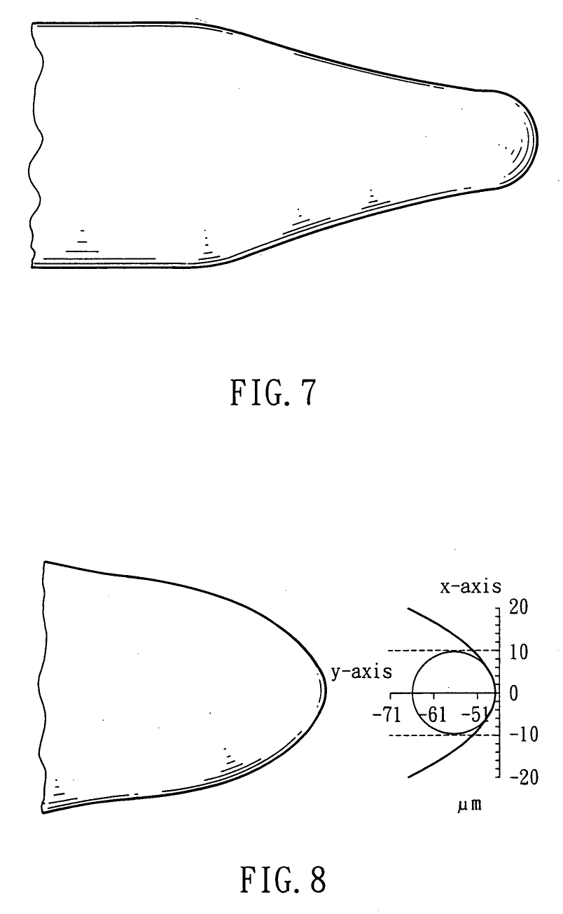

As shown in FIGS. 5 and 6, the most preferable radius of the curvature is 8 to 10 μm. In this step, the desired radius of the curvature of the fiber lens can be obtained by adjusting the distance between the central point of the two electric arcs 51,52 and the cone 23 (i.e., the x direction in FIG. 4). The shorter the distance is, the larger radius of curvature it forms, and the shape of the fiber lens is closer to hemispherical; the longer the distance is, the smaller radius of curvature it forms, and the shape of the fiber lens is closer to hyperbolic. In this present invention, when the distance between the central point of the two electric arcs 51,52 and the cone 23 is 0.5 mm, the final shape of the fiber lens is hemispherical and the radius of curvature is 8 to 10 μm, as shown in FIG. 7. When the distance between the central point of the two electric arcs 51,52 and the cone 23 is 1.1 mm, the final shape of the fiber lens is hyperbolic and the radius of curvature is 7 to 9 μm, as shown in FIG. 8.

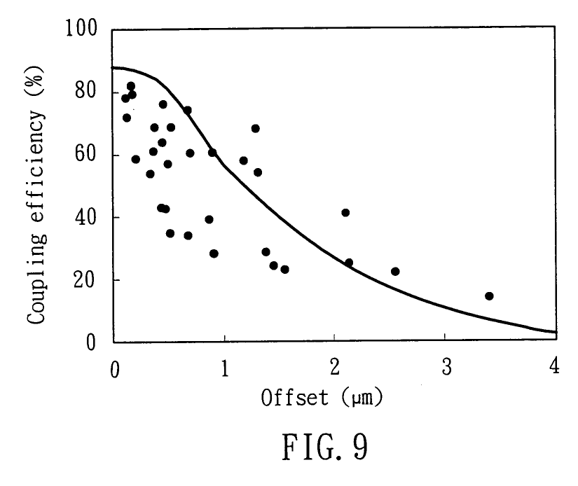

As shown in FIG. 9, another factor that influences the coupling efficiency is the offset between the axis of the fiber lens and the axis of the fiber body. The larger the offset is, the worse the coupling efficiency is. In order to reduce the offset, the fiber 20 in step S14 must be perpendicular to the surface of the layer of oil 41. The other way to reduce the offset is to control the relative position between the two electric arcs 51,52 and the cone 23 in vertical direction (i.e., the y direction in FIG. 4), that is, the distance between the electric arc 51 and the cone 23 must be equal to that between the electric arc 52 and the cone 23.

While several embodiments of this invention have been illustrated and described, various modifications and improvements can be made by those skilled in the art. The embodiments of this invention are therefore described in an illustrative but not restrictive sense. It is intended that this invention may not be limited to the particular forms as illustrated, and that all modifications that maintain the spirit and scope of this invention are within the scope as defined in the appended claims.

What is claimed is:

1. A method for fabricating a fiber lens, comprising:
(a) stripping proper length of a coating layer of a fiber to form a bare fiber portion;
(b) cleaning the bare fiber portion;
(c) fixing the fiber into a ferrule included in a holder;
(d) providing a container filled with a layer of hydrofloride, a layer of oil and a middle mixed layer;
(e) immersing the bare fiber portion of the fiber in the container, wherein the bare fiber portion of the fiber is etched by the layer of hydrofloride and the fiber is perpendicular to the surface of the layer of oil to form a cone;
(f) melting the cone by a plurality of electric arcs to form a fiber lens; and
(g) adjusting the relative position between the electric arcs and the cone to form a desired curvature and shape of the fiber lens.

2. The method according to claim 1, wherein the bare fiber portion in step (b) is washed by acetone, alcohol and deionized water.

3. The method according to claim 1, wherein the inner radius of the ferrule is equal to that of the fiber.

4. The method according to claim 1, wherein the thickness of the layer of oil is about 2 mm.

5. The method according to claim 1, wherein the concentration of the hydrofloride is 40% to 60%.

6. The method according to claim 1, wherein the etching time in step (e) is 30 to 50 minutes.

7. The method according to claim 1, wherein the distance between the central point of the electric arcs and the cone is about 1.1 mm.

8. The method according to claim 1, wherein the distance between the central point of the electric arcs and the cone is about 0.5 mm.

9. The method according to claim 1, wherein the radius of the curvature of the fiber lens in step (g) is 8 to 10 μm.

10. The method according to claim 1, wherein the offset between the axis of the fiber lens fabricated in step (g) and the axis of the fiber body is is below 1 μm.

11. The method according to claim 1, wherein the oil is motor oil.

12. The method according to claim 1, wherein the shape of the fiber lens is hyperbolic.

13. The method according to claim 1, wherein the shape of the fiber lens is hemispherical.

14. The method according to claim 1, wherein the ferrule is a ceramic ferrule.
